(19) United States
(12) Patent Application Publication
(10) Pub. No.: US 2021/0373905 A1
(43) Pub. Date: Dec. 2, 2021

(54) SYSTEMS AND METHODS FOR CLOUD-CENTRIC OPERATING SYSTEM DEPLOYMENT THROUGH SERVICE OPERATING SYSTEM

(71) Applicant: Dell Products L.P., Round Rock, TX (US)

(72) Inventors: Ibrahim SAYYED, Georgetown, TX (US); Chris E. PEPPER, Leander, TX (US); Chris C. GRIFFIN, Cedar Park, TX (US); Puri R. MALLURU, Round Rock, TX (US)

(73) Assignee: Dell Products L.P., Round Rock, TX (US)

(21) Appl. No.: 16/886,217

(22) Filed: May 28, 2020

(51) Int. Cl. G06F 9/4401

(52) U.S. Cl. CPC G06F 9/441

(57) ABSTRACT

An information handling system may include a processor, a basic input/output system (BIOS) communicatively coupled to the processor and configured to maintain a first variable indicative of whether auto-provisioning is enabled for the information handling system, maintain a second variable indicative of whether auto-provisioning has been completed for the information handling system, and upon boot of the information handling system, perform auto-provisioning of a host operating system image to the information handling system if the first variable indicates that auto-provisioning is enabled for the information handling system and the second variable indicates that auto-provisioning of the information handling system is incomplete.

### TECHNICAL FIELD

The present disclosure relates in general to information handling systems, and more specifically to cloud-centric operating system deployment through a service operating system of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Using existing approaches, no mechanism may be available to boot to a service operating system from a host operating system in order to install a factory operation system. In existing approaches, a basic input/output system (BIOS) may need to trigger a boot of a service operating system, which is a special boot option requiring manual user intervention and not a standard boot option for BIOS. Thus, these existing approaches render it difficult to perform automatic provisioning of a factory operating system using a cloud-centric operating system deployment solution triggered by a service operating system of an information handling system.

Further, existing solutions may require the presence of an interactive operating system agent in order to reimage an operating system.

### SUMMARY

In accordance with the teachings of the present disclosure, the disadvantages and problems associated with effective provisioning and deployment of an operating system may be reduced or eliminated.

In accordance with embodiments of the present disclosure, an information handling system may include a processor, a basic input/output system (BIOS) communicatively coupled to the processor and configured to maintain a first variable indicative of whether auto-provisioning is enabled for the information handling system, maintain a second variable indicative of whether auto-provisioning has been completed for the information handling system, and upon boot of the information handling system, perform auto-provisioning of a host operating system image to the information handling system if the first variable indicates that auto-provisioning is enabled for the information handling system and the second variable indicates that auto-provisioning of the information handling system is incomplete.

In accordance with these and other embodiments of the present disclosure, a method may include, in a basic input/output system (BIOS) of an information handling system, maintaining a first variable indicative of whether auto-provisioning is enabled for the information handling system, maintaining a second variable indicative of whether auto-provisioning has been completed for the information handling system, and upon boot of the information handling system, performing auto-provisioning of a host operating system image to the information handling system if the first variable indicates that auto-provisioning is enabled for the information handling system and the second variable indicates that auto-provisioning of the information handling system is incomplete.

In accordance with these and other embodiments of the present disclosure, an article of manufacture may include a computer readable medium and computer-executable instructions carried on the computer readable medium, the instructions readable by a processor, the instructions, when read and executed, for causing the processor to, in a basic input/output system (BIOS) of an information handling system: maintain a first variable indicative of whether auto-provisioning is enabled for the information handling system, maintain a second variable indicative of whether auto-provisioning has been completed for the information handling system, and upon boot of the information handling system, perform auto-provisioning of a host operating system image to the information handling system if the first variable indicates that auto-provisioning is enabled for the information handling system and the second variable indicates that auto-provisioning of the information handling system is incomplete.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates a flow chart of an example method for cloud-centric operating system deployment via a service operating system, in accordance with certain embodiments of the present disclosure; and

FIG. 3 illustrates a flow chart of an example lifecycle flow for an information handling system, in accordance with certain embodiments of the present disclosure.

### DETAILED DESCRIPTION

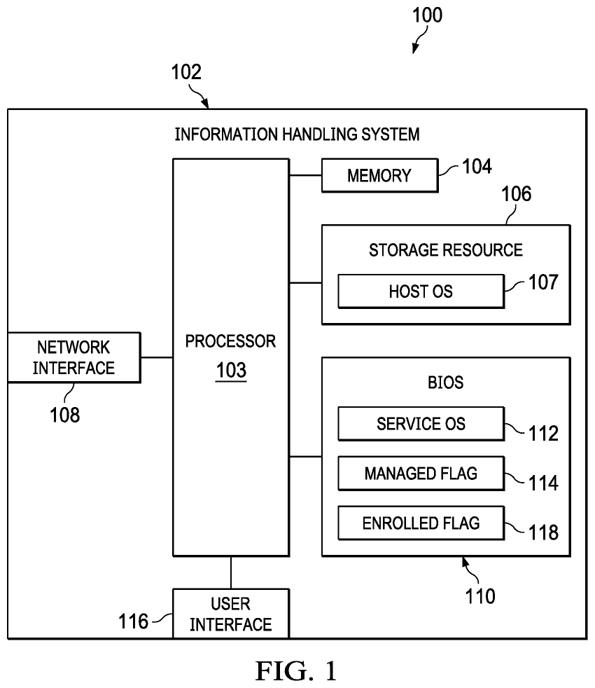

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), busses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). As depicted in FIG. 1, information handling system 102 may include a processor 103, a memory 104 communicatively coupled to processor 103, a storage resource 106 communicatively coupled to processor 103, a network interface 108 communicatively coupled to processor 103, a basic input/output system (BIOS) 110 communicatively coupled to processor 103, and a user interface 116 coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 106, BIOS 110, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Storage resource 106 may be communicatively coupled to processor 103 and may include any system, device, or apparatus configured to retain program instructions or data for a period of time (e.g., a computer-readable medium). In some embodiments, storage resource 106 may include a hard disk drive, a magnetic tape library, an optical disk drive, a magneto-optical disk drive, a compact disc drive, a solid state storage drive, a flash drive and/or any other suitable computer-readable medium. In some embodiments, storage resource 106 may reside internal to a chassis or other enclosure comprising information handling system 102 and not be readily accessible without opening such chassis or other enclosure. In other embodiments, storage resource 106 may reside internal to a chassis or other enclosure comprising information handling system 102. As shown in FIG. 1, storage resource 106 may have stored thereon a host operating system (OS) 107.

Host operating system 107 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by host OS 107. Active portions of host OS 107 may be transferred from storage resource 106 to memory 104 for execution by processor 103.

Network interface 108 may comprise any suitable system, apparatus, or device operable to serve as an interface between information handling system 102 and a network comprising one or more other information handling systems. Network interface 108 may enable information handling system 102 to communicate over such a network using any suitable transmission protocol and/or standard, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network interface 108 may interface with one or more networks implemented as, or as part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). In certain embodiments, network interface 108 may comprise a network interface card, or “NIC.” Although not shown in FIG. 1, network interface 108 may be communicatively coupled via a network to a provisioning server from which information handling system 102 may download software and firmware components of information handling system 102, including without limitation an image for host OS 107.

BIOS 110 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102. As shown in FIG. 1, BIOS 110 may comprise a service OS 112, a managed flag 114, and an enrolled flag 118.

Service OS 112 may comprise a special-purpose, limited functionality operating system that may be used for management and/or diagnostics of information handling system 102. As described in greater detail below, service OS 112 may also include a deployment agent to facilitate cloud-centric deployment of an image of host OS 107.

Managed flag 114 may be a variable set during factory provisioning of information handling system 102 and/or set by a user (e.g., administrator) of information handling system 102 to indicate whether or not information handling system 102 is managed by an information technology (IT) policy for automatic provisioning. Thus, in some embodiments, managed flag 114 may be a binary variable (e.g., “1” or “TRUE” indicates information handling system 102 is managed by IT policy for automatic provisioning).

Enrolled flag 118 may be a variable set during operation of service OS 112 to indicate whether or not information handling system 102 is enrolled for automatic provisioning. Thus, in some embodiments, enrolled flag 118 may be a binary variable (e.g., “1” or “TRUE” indicates information handling system 102 is enrolled for automatic provisioning).

User interface 116 may comprise any instrumentality or aggregation of instrumentalities by which a user may interact with information handling system 102. For example, user interface 116 may permit a user to input data and/or instructions into information handling system 102 (e.g., via a keyboard, pointing device, and/or other suitable component), and/or otherwise manipulate information handling system 102 and its associated components. User interface 116 may also permit information handling system 102 to communicate data to a user, e.g., by way of a display device.

In operation, BIOS 110 may verify if information handling system 102 is meant to be provisioned by the deployment agent of service OS 112 by reading the value of managed flag 114. If the value of managed flag 114 indicates that information handling system 102 is not managed by an IT policy for automatic provisioning (e.g., a value of “0” or “FALSE”), BIOS 110 may follow standard host OS 107 recovery flow based on a boot failure threshold. BIOS 110 may also determine the value of enrolled flag 118 to determine whether to boot to service OS 112 for automatic provisioning of host OS 107, as described in greater detail below.

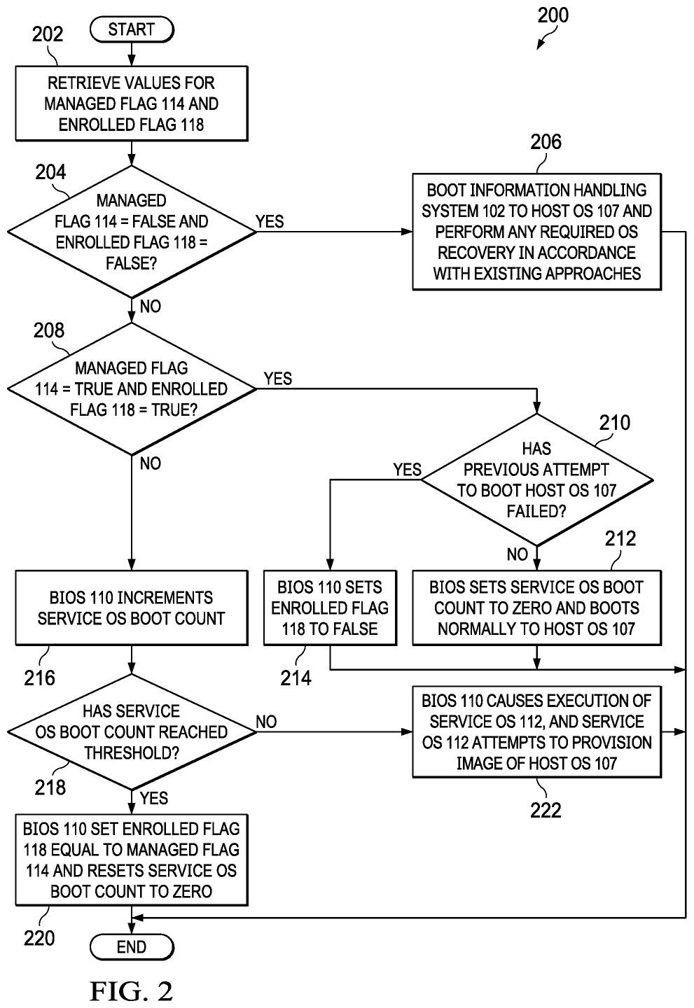

FIG. 2 illustrates a flow chart of an example method 200 for cloud-centric operating system deployment via a service operating system, in accordance with certain embodiments of the present disclosure. According to one embodiment, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, upon execution of BIOS 110 upon an attempted boot or reboot of information handling system 102, BIOS 110 may determine the values for managed flag 114 and enrolled flag 118. At step 204, BIOS 110 may determine if managed flag 114 and enrolled flag 118 are both set to “FALSE.” If managed flag 114 and enrolled flag 118 are both set to “FALSE,” method 200 may proceed to step 206. Otherwise, method 200 may proceed to step 208.

At step 206, responsive to managed flag 114 and enrolled flag 118 both being set to “FALSE,” BIOS 110 may boot information handling system 102 to host OS 107 and perform any required OS recovery in accordance with existing approaches. After completion of step 206, method 200 may end.

At step 208, BIOS 110 may determine if managed flag 114 and enrolled flag 118 are both set to “TRUE.” If managed flag 114 and enrolled flag 118 are both set to “TRUE,” method 200 may proceed to step 210. Otherwise, method 200 may proceed to step 216.

At step 210, responsive to managed flag 114 and enrolled flag 118 both being set to “TRUE,” BIOS 110 may determine if the previous attempt to boot host OS 107 failed. If the previous attempt to boot host OS 107 failed, method 200 may proceed to step 214. Otherwise, if the previous attempt to boot host OS 107 was successful, method 200 may proceed to step 212.

At step 212, responsive to the previous attempt to boot host OS 107 being successful, BIOS 110 may reset a service OS boot count to zero and boot normally to host OS 107. After completion of step 212, method 200 may end.

At step 214, responsive to the previous attempt to boot host OS 107 having failed, BIOS 110 may set enrolled flag 118 to “FALSE,” such that on the subsequent boot of information handling system 102, service OS 112 will provision an image of host OS 107. After completion of step 214, method 200 may end.

At step 216, which may occur if managed flag 114 is set to “TRUE” and enrolled flag 118 is set to “FALSE” or if managed flag 114 is set to “FALSE” and enrolled flag 118 is set to “TRUE,” BIOS 110 may increment a service OS boot count. Managed flag 114 may be set to “FALSE” and enrolled flag 118 set to “TRUE,” for example, when an administrator of information handling system 102 desires to remove information handling system 102 from a managed pool of systems but not immediately impact a user.

At step 218, BIOS 110 may determine if the service OS boot count has reached a threshold (e.g., three). If the threshold has been reached (indicating an error), method 200 may proceed to step 220. Otherwise, method 200 may proceed to step 222.

At step 220, in response to the threshold being reached, BIOS 110 may set enrolled flag 118 equal to managed flag 114 in order to attempt normal boot on a subsequent boot and reset the service OS boot count to zero. After completion of step 220, method 200 may end.

At step 222, responsive to the threshold not yet being reached, BIOS 110 may cause execution of service OS 112, and service OS 112 may attempt to provision an image of host OS 107 (e.g., via network interface 108) onto information handling system 102. After completion of step 222, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

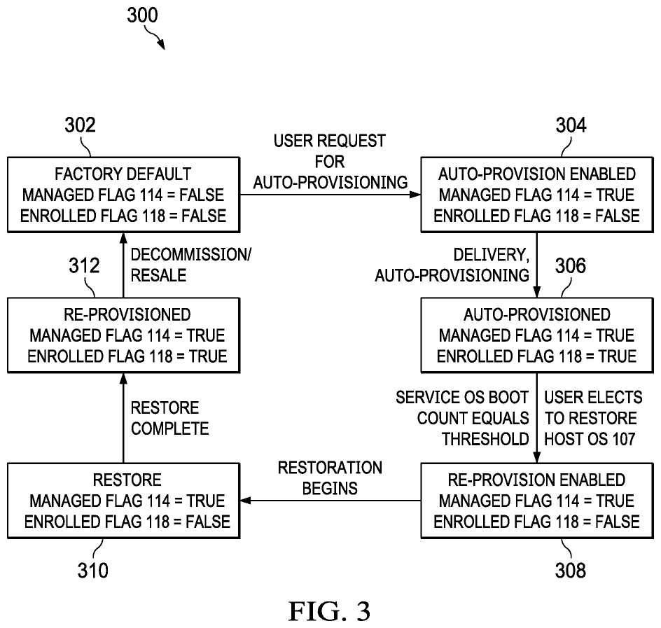

FIG. 3 illustrates a flow chart of an example lifecycle flow 300 for information handling system 102, in accordance with certain embodiments of the present disclosure. In particular, FIG. 3 represents various example stages in the lifespan of information handling system 102 that may occur in accordance with method 200 of FIG. 2.

An information handling system 102 may begin its lifecycle in the factory default 302 stage, wherein managed flag 114 and enrolled flag 118 may be set to “FALSE.” However, during factory provisioning of information handling system 102, in response to a user request (e.g., request by the individual or entity acquiring information handling system 102), managed flag 114 may be set to “TRUE” at auto-provision enabled stage 304 to enable auto-provisioning of information handling system 102.

Information handling system 102 may be delivered to the user, physically deployed to its intended end use location, and powered on, leading to information handling system 102 being auto-provisioned with an image for host OS 107 due to the values of managed flag 114 and enrolled flag 118. After auto-provisioning, information handling system 102 may be in auto-provisioned stage 306, wherein enrolled flag 118 may be set to “TRUE.”

At some point after auto-provisioning, information handling system 102 may require a restoration of host OS 107. For example, in some instances, a user may elect to restore host OS 107, which may lead to enrolled flag 118 being set to “FALSE.” As another example, in some instances, a service OS boot count may reach a relevant threshold, which may cause BIOS 110 to set enrolled flag 118 to “FALSE.” In either case, information handling system 102 may reach a re-provision enabled stage 308.

In response to enrolled flag 118 being set to FALSE, on a subsequent boot of information handling system 102, information handling system 102 may be in a restore stage 310 wherein the restoration/re-provisioning of host OS 107 may take place. After such restoration is complete, BIOS 110 may set enrolled flag 118 to “TRUE” and information handling system 102 may enter re-provisioned stage 312.

At some point during its lifecycle, a user may desire to decommission or resell information handling system 102. To do so, a user may manually set managed flag 114 and enrolled flag 118 back to factory defaults of “FALSE”, thus disabling auto-provisioning and returning information handling system 102 to factory default stage 302.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a basic input/output system (BIOS) communicatively coupled to the processor and configured to:
maintain a first variable indicative of whether auto-provisioning is enabled for the information handling system;
maintain a second variable indicative of whether auto-provisioning has been completed for the information handling system; and
upon boot of the information handling system, perform auto-provisioning of a host operating system image to the information handling system if the first variable indicates that auto-provisioning is enabled for the information handling system and the second variable indicates that auto-provisioning of the information handling system is incomplete.

2. The information handling system of claim 1, wherein the BIOS is further configured to set the second variable to a value indicating that auto-provisioning has been completed for the information handling system responsive to completion of auto-provisioning of the information handling system.

3. The information handling system of claim 1, wherein the BIOS is further configured to set the second variable to a value indicating that auto-provisioning is incomplete responsive to a boot failure occurring during a prior attempt to boot to the host operating system.

4. The information handling system of claim 3, wherein the BIOS is further configured to, on a subsequent boot, restore the host operating system image to the information handling system as a result of the setting of the second variable to the value indicating that auto-provisioning is incomplete.

5. The information handling system of claim 1, wherein the BIOS is further configured to set the second variable to a value indicating that auto-provisioning is incomplete responsive to a user input indicating a desire to change the second variable.

6. The information handling system of claim 5, wherein the BIOS is further configured to, on a subsequent boot, restore the host operating system image to the information handling system as a result of the setting of the second variable to the value indicating that auto-provisioning is incomplete.

7. A method comprising, in a basic input/output system (BIOS) of an information handling system:
maintaining a first variable indicative of whether auto-provisioning is enabled for the information handling system;
maintaining a second variable indicative of whether auto-provisioning has been completed for the information handling system; and
upon boot of the information handling system, performing auto-provisioning of a host operating system image to the information handling system if the first variable indicates that auto-provisioning is enabled for the information handling system and the second variable indicates that auto-provisioning of the information handling system is incomplete.

8. The method of claim 7, further comprising setting the second variable to a value indicating that auto-provisioning has been completed for the information handling system responsive to completion of auto-provisioning of the information handling system.

9. The method of claim 7, further comprising setting the second variable to a value indicating that auto-provisioning is incomplete responsive to a boot failure occurring during a prior attempt to boot to the host operating system.

10. The method of claim 9, further comprising, on a subsequent boot of the information handling system, restoring the host operating system image to the information handling system as a result of the setting of the second variable to the value indicating that auto-provisioning is incomplete.

11. The method of claim 7, further comprising setting the second variable to a value indicating that auto-provisioning is incomplete responsive to a user input indicating a desire to change the second variable.

12. The method of claim 11, further comprising, on a subsequent boot of the information handling system, restoring the host operating system image to the information handling system as a result of the setting of the second variable to the value indicating that auto-provisioning is incomplete.

13. An article of manufacture comprising:
a computer readable medium; and
computer-executable instructions carried on the computer readable medium, the instructions readable by a processor, the instructions, when read and executed, for causing the processor to, in a basic input/output system (BIOS) of an information handling system:
maintain a first variable indicative of whether auto-provisioning is enabled for the information handling system;
maintain a second variable indicative of whether auto-provisioning has been completed for the information handling system; and
upon boot of the information handling system, perform auto-provisioning of a host operating system image to the information handling system if the first variable indicates that auto-provisioning is enabled for the information handling system and the second variable indicates that auto-provisioning of the information handling system is incomplete.

14. The article of claim 13, the instructions for further causing the processor to set the second variable to a value indicating that auto-provisioning has been completed for the information handling system responsive to completion of auto-provisioning of the information handling system.

15. The article of claim 13, the instructions for further causing the processor to set the second variable to a value indicating that auto-provisioning is incomplete responsive to a boot failure occurring during a prior attempt to boot to the host operating system.

16. The article of claim 15, the instructions for further causing the processor to, on a subsequent boot of the information handling system, restore the host operating system image to the information handling system as a result of the setting of the second variable to the value indicating that auto-provisioning is incomplete.

17. The article of claim 13, the instructions for further causing the processor to set the second variable to a value indicating that auto-provisioning is incomplete responsive to a user input indicating a desire to change the second variable.

18. The article of claim 17, the instructions for further causing the processor to, on a subsequent boot of the information handling system, restore the host operating system image to the information handling system as a result of the setting of the second variable to the value indicating that auto-provisioning is incomplete.
